(19) United States
(12) Patent Application Publication
(10) Pub. No.: US 2025/0232429 A1
(43) Pub. Date: Jul. 17, 2025

(54) SYSTEMS AND METHODS FOR VISUAL INSPECTION OF PHARMACEUTICAL CONTAINERS

(71) Applicant: Applied Materials, Inc., Santa Clara, CA (US)

(72) Inventors: Asaf SCHLEZINGER, Modi'in (IL); Lang QIN, Singapore (SG)

(21) Appl. No.: 18/409,979

(22) Filed: Jan. 11, 2024

(51) Int. Cl. G06T 7/00

(52) U.S. Cl. CPC G06T 7/001; G06T 2207/10004; G06T 2207/30108

(57) ABSTRACT

Systems and methods for fluid inspection are disclosed. The system includes a transportation system to transport a plurality of containers of fluid through an inspection zone, one or more cameras operable to view the plurality of containers from a first direction, and a back illuminator positioned to direct light in a second direction while the plurality of containers are in the inspection zone. The second direction is oriented greater than 90 degrees and less than 180 degrees from the first direction. The system further includes a controller electrically coupled to the back illuminator and the one or more cameras. The controller is operable to cause the back illuminator to emit light in the second direction while the plurality of containers are in the inspection zone and capture a plurality of images of the fluid in the plurality of containers while being illuminated by the back illuminator.

### TECHNICAL FIELD

The present disclosure relates generally to pharmaceutical containers and more particularly, but not by way of limitation, to systems and methods for visual inspection of pharmaceutical containers.

### BACKGROUND

This section provides background information to facilitate a better understanding of the various aspects of the disclosure. It should be understood that the statements in this section of this document are to be read in this light, and not as admissions of prior art.

Pharmaceutical fluids such as medications, supplements, or other drugs may be stored in containers, such as vials, ampules, cartridges, and pre-filled syringes. To ensure the proper, and safe preparation of these fluids, the pharmaceutical industry is focused on the inspection of the fluids while in the containers to ensure quality and safety of the product. For some medicinal and/or supplement products, inspections may be done for quality assurance or as a requirement of government or industry regulations.

For instance, the Food and Drug Administration requires inspection of all parenteral containers. That is, every vial, syringe, ampule, cartridge, and the like needs to be inspected to ensure the contents are defect free. This includes, for example, being free of glass residues, fibers, plastic and/or rubber residues, and combinations of the same and like. Any container identified to have a foreign object within it must be removed. However, many of these containers have air bubbles that may be confused with foreign objects such as glass particles. Air bubbles are not considered a defect, and therefore should be ignored when analyzing potential defects within the contents. Often times, these air bubbles may be falsely identified as glass particles which can lead to acceptable containers being removed during manufacturing. This may ultimately increase overall time and manufacturing costs.

Therefore, what is needed is a system and method for the inspection of pharmaceutical fluids and the like, that allows for fast, accurate differentiation of glass particles from air bubbles in pharmaceutical containers.

### SUMMARY OF THE INVENTION

This summary is provided to introduce a selection of concepts that are further described below in the Detailed Description. This summary is not intended to identify key or essential features of the claimed subject matter, nor is it to be used as an aid in limiting the scope of the claimed subject matter.

In one embodiment, a fluid inspection system is provided. The fluid inspection system includes a transportation system operable to transport a plurality of containers of fluid through an inspection zone, one or more cameras operable to view a front side of the plurality of containers from a first direction while the plurality of containers are in the inspection zone, and a back illuminator positioned to direct light in a second direction on a backside of the plurality of containers while the plurality of containers are in the inspection zone. The second direction is oriented greater than 90 degrees and less than 180 degrees from the first direction. The fluid inspection system further includes a controller electrically coupled to the back illuminator and the one or more cameras. The controller is operable to cause the back illuminator to emit light that illuminates the backside of the plurality of containers in the second direction while the plurality of containers are in the inspection zone and capture a plurality of images of the fluid in the plurality of containers while being illuminated by the back illuminator. The plurality of containers receive more light intensity from the second direction than from other directions illuminating the backside of the plurality of while the plurality of images are being captured.

In another embodiment, a method for fluid inspection is provided. The method includes causing an angled, back illuminator to emit pulses of light directed to a plurality of containers disposed in an inspection zone, capturing a plurality of images of a fluid in the plurality of containers disposed in the inspection zone, and identifying an impurity in the fluid based on at least one image of the plurality of images. The container receives more light intensity from the first direction than from other directions illuminating a backside of the container while the image is being captured

In yet another embodiment, a fluid inspection system is provided. The fluid inspection system includes a transportation system operable to transport a plurality of containers of fluid through an inspection zone and a plurality of illuminators having at least one front illuminator directed to the inspection zone, a back illuminator directed to an opposing direction of the at least one front illuminator, and a transmission mode illuminator directed to the opposing direction of the at least one front illuminator. The fluid inspection system further includes one or more cameras directed to the inspection zone and a controller electrically coupled to the plurality of illuminators and the one or more cameras. The controller is operable to cause the back illuminator to emit pulses of light, capture a plurality of images of the fluid in the plurality of containers disposed in the inspection zone, and identify an impurity in the fluid based on at least one image of the plurality of images. The plurality of containers receive more light intensity from the back illuminator than from other illuminators illuminating a backside of the plurality of while the plurality of images are being captured

### BRIEF DESCRIPTION OF THE DRAWINGS

A more complete understanding of the subject matter of the present disclosure may be obtained by reference to the following Detailed Description when taken in conjunction with the accompanying Drawings wherein:

FIG. 1 illustrates a schematic view of an inspection system, according to embodiments described herein.

FIG. 2 illustrates an isometric view of portions of the inspection system of FIG. 1, according to embodiments described herein.

FIG. 3A illustrates a diagram showing light refraction through an air bubble and a resulting image outline of the air bubble, according to embodiments described herein.

FIG. 3B illustrates a diagram showing light refraction through a glass particle and resulting image outline of the glass particle, according to embodiments described herein.

FIG. 4 illustrates a flow diagram of a method for fluid inspection, according to embodiments described herein.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

It is to be understood that the following disclosure provides many different embodiments, or examples, for implementing different features of various embodiments. Specific examples of components and arrangements are described below to simplify the disclosure. These are, of course, merely examples and are not intended to be limiting. The section headings used herein are for organizational purposes and are not to be construed as limiting the subject matter described.

Embodiments of the present disclosure generally relate to systems and methods for product inspection, and more particularly to systems and methods for the inspection of fluids for defects (e.g., glass particles). The systems and methods described herein are particularly advantageous for the inspection of pharmaceutical fluids, but has equal application to the inspection of other types of fluids. In this context, ‘pharmaceutical’ is not meant to be limiting as to the type of fluid described below, but provided as an example of a fluid that requires defect inspection. Accordingly, any fluid may be inspected with the disclosed systems and methods.

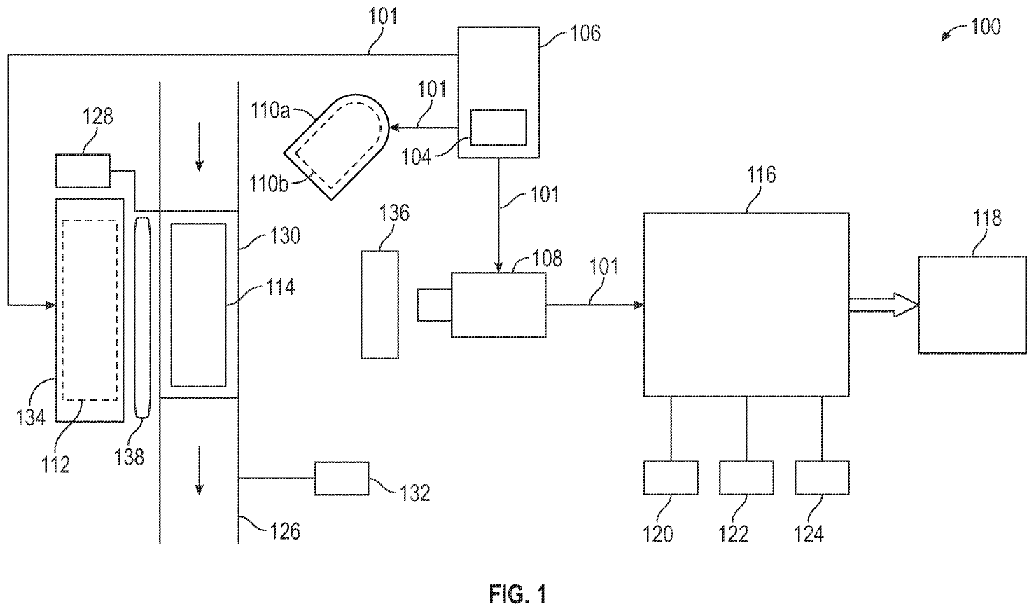

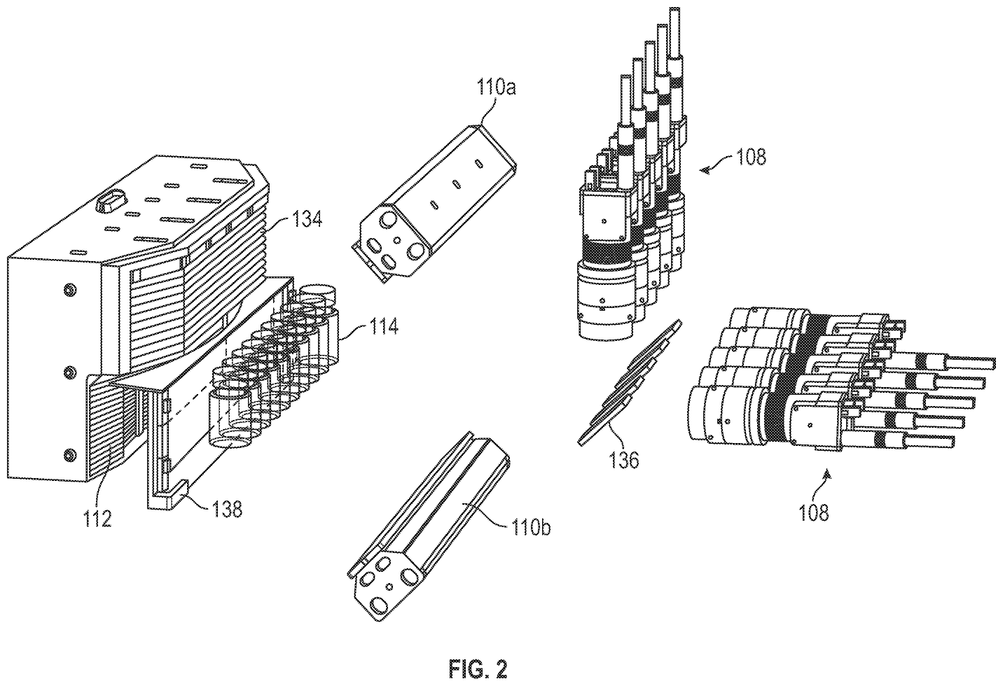

FIG. 1 shows a schematic view of an inspection system 100. FIG. 2 shows an isometric view of portions of the inspection system 100 of FIG. 1. For clarity, FIGS. 1-2 will be described collectively. The inspection system 100 is operable to inspect fluids disposed in the container 114. The inspection system 100 is configured to capture a plurality of images of fluids (such as a pharmaceutical fluid or other fluid) that are contained in containers 114, such as vials, ampules, cartridges and pre-filled syringes, among other containers. The images are utilized to identify and/or characterize defects in the fluids. The inspection system 100 is not limited in the type of pharmaceutical or other fluid that may be inspected.

The inspection system 100 includes a trigger timing generator 104, a controller 106, front illuminators 110a-b (collectively referred to as front illuminators 110), a transmission mode illuminator 112, a back illuminator 134, one or more cameras 108, a computer system 116, a transportation system 126, a sensor 128, and a motor 132. The trigger timing generator 104, the controller 106, the camera 108, the front illuminators 110, the transmission mode illuminator 112, the back illuminator 134, the computer system 116, the transportation system 126, and the sensor 128 may communicate via communication links 101 or wirelessly.

The containers 114 are provided to an inspection zone 130 of the inspection system 100 by the transportation system 126. The transportation system 126 includes, but is not limited to, a conveyor, a carousel, a robot, a pallet, or other container transportation systems operable to move the containers 114 into the inspection zone 130. The transportation system 126 is also configured to move the containers 114 out of the inspection zone 130 after inspection. In certain embodiments, the transportation system 126 is configured to separate containers that have been identified as having a defect or impurity (e.g., a glass particle). During inspection, the containers 114 may be stationary in the inspection zone 130 or may be moving through the inspection zone 130. For example, the transportation system 126 may move the containers 114 to the inspection zone 130, pause the motion of the containers 114 during inspection while in the inspection zone 130, then move inspected containers 114 out of the inspection zone 130 so that a next container 114 may be moved to the inspection zone 130 for inspection. In another example, the transportation system 126 may continuously move the containers 114 through the inspection zone 130 while the containers 114 are being inspected, for example while on a conveyor.

The sensor 128 is interfaced with the transportation system 126 in a position that enables the sensor 128 to detect the position of the containers 114 while being carried by the transportation system 126. In one example, the sensor 128 may detect when the containers 114 are in the inspection zone 130. In another example, the sensor 128 may detect when the containers 114 are at a position along the transportation system 126 so that the timing of when the containers 114 will be in the inspection zone 130 can be determined. The sensor 128 generates a trigger signal when the presence of the container 114 is detected on the transportation system 126. For example, the trigger signal may be generated when the sensor 128 detects the containers 114 are in the inspection zone 130 or when the containers 114 are at a pre-determined position from which it can be determined when the containers 114 will arrive in the inspection zone 130 for inspection. The sensor 128 is coupled to, and provides the trigger signal to the controller 106.

The controller 106 is configured to facilitate the control of the inspection process described herein. The controller 106 is in communication with the front illuminators 110, the transmission mode illuminator 112, the back illuminator 134, and the one or more cameras 108 via the communication links 101. The controller 106 is in communication with the sensor 128. Using the trigger signal provided by the sensor 128, the controller 106 determines the positional information of the containers 114 relative to the inspection zone 130. In embodiments where the controller 106 receives a trigger signal indicative of the transportation system 126 moving the containers 114 towards the inspection zone 130, the controller 106 may utilize speed information (either from a look-up table, system library, sensed or otherwise provided) to determine when the containers 114 will arrive in the inspection zone 130 and be ready for inspection.

In one example, the trigger timing generator 104 is software that is executable by the controller 106. The trigger timing generator 104 may alternatively be hardware, a combination of hardware and software, or a separate controller. The trigger timing generator 104 is operable to generate a timing sequence to be utilized by the controller 106 to obtain inspection data from the fluid disposed in the containers 114 present in the inspection zone 130. The controller 106 instructs the front illuminators 110, the back illuminator 134, and/or the transmission mode illuminator 112 to provide the pulses of light that illuminate the inspection zone 130 (e.g., according to the timing sequence). The controller 106 controls the sequence of pulses of light that are provided to the inspection zone 130. In some embodiments, the sequence of pulses of light are based on the timing sequence. The timing sequence may include instructions regarding intervals between the pulses of light.

The controller 106 may control the timing and operation of the one or more cameras 108 so as to capture the plurality of images of the fluid disposed in the containers 114 in the inspection zone 130. In certain embodiments, the timing and operation of the one or more cameras 180 are based on the timing sequence. The plurality of images taken by the one or more cameras 180 may become the inspection data utilized to inspect the fluid disposed in the containers 114, for example, to identify an impurity in the fluid. The timing sequence, based on the trigger signal (and in some instances additionally container speed information), allows the controller 106 to begin the inspection process when the containers 114 are in the inspection zone 130.

As discussed above, the trigger signal and optionally the speed information provided to the controller 106 allows for the controller 106 to initiate the instructions to the front illuminators 110, the transmission mode illuminator 112, the back illuminator 134, and/or the one or more cameras 108 when the containers 114 are in the inspection zone 130. The controller 106, based on the timing sequence provided by the trigger timing generator 104, ensures that the pulses of light are provided simultaneously with the capturing of fluid images by one or more cameras 108 when the containers 114 are in the inspection zone 130.

The front illuminators 110, the back illuminator 134, and the transmission mode illuminator 112 are configured to provide the pulses of light to illuminate the containers 114 while the containers 114 are in the inspection zone 130. The positioning of the front illuminators 110, the back illuminator 134, and the transmission mode illuminator 112, as disclosed below, form asymmetric illumination across the inspection zone 130.

The front illuminators 110 are directed towards the inspection zone 130. The front illuminators 110 may be directed to the inspection zone 130 at an acute, or obtuse angle relative to a same plane of the transmission mode illuminator 112 and the containers 114. For example, as shown in FIG. 2, the front illuminator 110a may be directed at an angle less than 90 degrees relative to the same plane of the transmission mode illuminator 112 and the containers 114, while the illuminator 110b may be directed at an angle greater than 180 degrees relative to a same plane of the transmission mode illuminator 112 and the containers 114. In certain embodiments, the front illuminators 110 may be reflection mode illuminators. The front illuminators 110 are configured to project light to the containers 114 such that the light is reflected off of the containers 114 and the fluid disposed therein. The light is reflected from the containers 114 and the fluids towards the camera 108.

The transmission mode illuminator 112 is directed in an opposing direction of the front illuminators 110. The transmission mode illuminator 112 may be directed to the inspection zone 130 in the same plane as the containers 114. The transmission mode illuminator 112 is configured to project light through the containers 114 and the fluids disposed therein. The light is transmitted through the containers 114 and the fluids to the camera 108. A diffuser and/or filter 138 is disposed between the transmission mode illuminator 112 and the one or more cameras 108. In certain embodiments, as light is traveling through the containers 114, light from the transmission mode illuminator 112 may be blocked by defects in the containers 114. The blocking of the light causes shadows in images taken by the one or more cameras 108 resulting in dark portions to appear in regions where defects are present.

The back illuminator 134 is directed in an opposing direction of the front illuminators 110. As shown in FIG. 2, the back illuminator 134 is positioned to direct light in a direction towards a back side of containers 114. In some embodiments, the direction may be oriented greater than 90 degrees and less than 180 degrees from a direction the one or more cameras 108 view fluid within the containers 114. In some embodiments, the direction may be oriented greater than 100 degrees and less than 120 degrees from a direction the one or more cameras 108 view fluid within the containers 114. In some embodiments, the direction may be oriented greater than 110 degrees and less than 160 degrees from a direction the one or more cameras 108 view fluid within the containers 114. In some embodiments, the direction may be oriented approximately 135 degrees from a direction the one or more cameras 108 view fluid within the containers 114.

In certain embodiments, the back illuminator 134 may be reflection mode illuminators. The back illuminator 134 is configured to project light to the containers 114 such that the light is refracted through the containers 114 and the fluid disposed therein. The light is transmitted through the containers 114 and the fluids to the camera 108. As light travels through the containers 114, refraction of light occurs when the light passes through a defect. The refraction of light causes a portion of the light to pass through the containers 114 such that images taken by the one or more cameras 108 result in bright portions to appear in a portion of a region where a defect is present.

Defects within the containers 114 have varying refractive indexes. Such variations in the refractive index causes light and dark portions to appear in different regions when images are taken by the one or more cameras 108. For example, air bubbles in fluid within containers 114 may result in a dark portion being at a bottom position and a light portion being at a top position. Conversely, glass particles in fluid within containers 114 may result in a light portion being at a bottom position and a dark portion being at a top position. Such changes in the position of the light and dark portions allow for differentiation between air bubbles and glass particles within the fluid. Similarly, when for example white fibers are present in the fluid, only a light portion appears, and when metal is present in the fluid, only a dark portion appears.

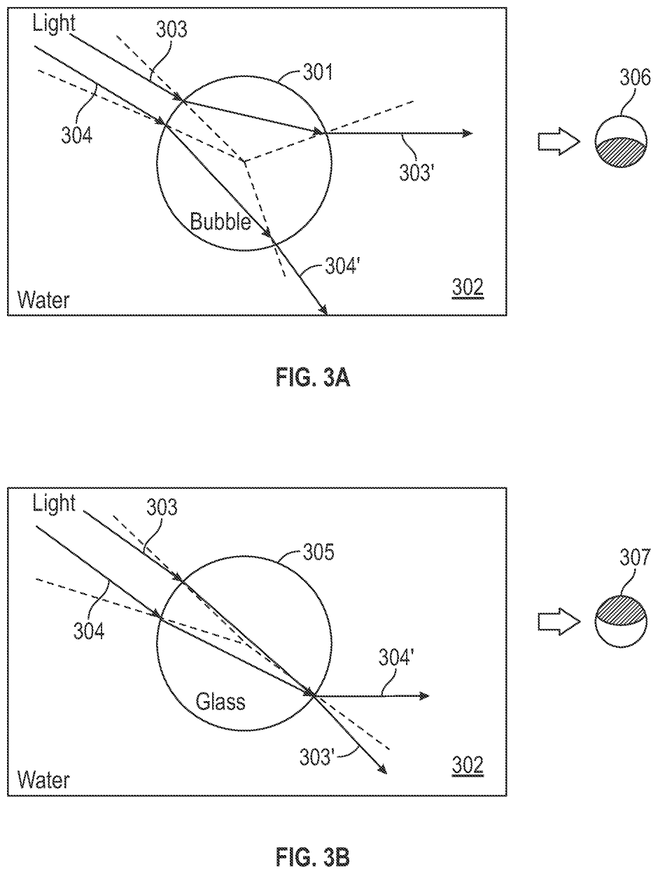

FIGS. 3A-B outlines the above refractive properties when light from the back illuminator 134 is refracted through a defect and to the camera 108. FIG. 3A illustrates a diagram showing light refraction through an air bubble 301 and a resulting image outline 306 of the air bubble 301, according to embodiments described herein. Light waves 303 and 304 enter a fluid 302. When the light waves 303 and 304 refract through the air bubble 301, light waves 303 and 304 exit the air bubble 301 as refracted light waves 303′ and 304′, respectively. As can be seen in FIG. 3A, refracted light wave 303′ exits the air bubble 301 such that refracted light wave 303′ is received by the camera 108. However, refractive light wave 304′ is not received by the camera 108, resulting in an image outline 306 having a light portion on top and a dark portion on bottom.

FIG. 3B illustrates a diagram showing light refraction through a glass particle 305 and resulting image outline 307 of the glass particle 305, according to embodiments described herein. In FIG. 3B, light waves 303 and 304 enter fluid 302, and when the light waves 303 and 403 refract through glass particle 305, light waves 303 and 304 exit the glass particle 305 as refracted light waves 303′ and 304′, respectively. As can be seen in FIG. 3B, refracted light wave 304′ exits the glass particle 305 such that refracted light wave 304′ is received by the camera 108. However, refractive light wave 303′ is not received by the camera 108, resulting in an image outline 306 having a light portion on top and a dark portion on bottom. Advantageously, such identification and/or differentiation allows for high-accuracy classification of defects within containers 114.

Based on refractive properties of the defects, additional configuration of the positioning of the front illuminators 110, the back illuminator 134, and/or the transmission mode illuminator 112 are readily envisioned. Similar principals, as described above, apply to inspection systems 100 having any asymmetric illumination configuration across the inspection zone 130. For example, the direction of the back illuminator 134 may be oriented greater than 180 degrees and less than 270 degrees from a direction the one or more cameras 108 view the fluid within containers 114. In some embodiments, the direction may be oriented greater than 190 degrees and less than 280 degrees from a direction the one or more cameras 108 view fluid within the containers 114. In some embodiments, the direction may be oriented approximately 210 degrees from a direction the one or more cameras 108 view fluid within the containers 114.

In such configurations, air bubbles in fluid within containers 114 may result in a light portion being at a bottom position and a dark portion being at a top position, while conversely glass particles may result in a dark portion being at a bottom position and a light portion being at a top position. As such, the back illuminator 134 may face various directions (e.g., varying angles relative to the direction the camera 108 faces the fluid within containers 114) and produce corresponding light and dark portions in images representative of defects within the fluid. While FIG. 3B illustrates impurities as spherical shapes, these shapes are not intended to be limiting. For example, glass particle may be in any shape. The inspection system 100 disclosed herein may separate all shapes of impurities, such as glass, from air bubbles as impurities may be differentiated from air bubbles as described above.

Turning back to FIGS. 1-2, the inspection system 100 is not limited to two front illuminators 110, one back illuminator 134, and one transmission mode illuminator 112. The inspection system 100 may include one or more of each of the front illuminator 110, the back illuminator 134, and the transmission mode illuminator 112. For example, the inspection system 100 may include one transmission mode illuminator 112 and one back illuminator 134, or any combination of illuminators. The front illuminators 110, the back illuminator 134, and the transmission mode illuminator 112 provide the pulses of light according to the timing sequence provided by the controller 106.

The front illuminators 110, the transmission mode illuminator 112, and the back illuminator 134 may alternate between an “off” position, where no light is projected, and an “on” position, where light is projected to the inspection zone 130 to be incident on the container 114 positioned in the inspection zone 130. The sequence of toggling from the “off” position, to the “on” position, and back to the “off” position, is defined as a pulse. The front illuminators 110, the transmission mode illuminator 112, and/or the back illuminator 134 are toggled from the “off” position to the “on” position according to the timing sequence executed by the controller 106. The “off” position may be achieved by turning off the front illuminators 110, the transmission mode illuminator 112, and/or the back illuminator 134 or by closing a shutter on the front illuminators 110, the transmission mode illuminator 112, and/or the back illuminator 134 to block the light. The “on” position may be achieved by turning on the front illuminators 110, the transmission mode illuminator 112, and/or the back illuminator 134 or by opening a shutter on the front illuminators 110, the transmission mode illuminator 112, and/or the back illuminator 134 to provide light to the inspection zone 130.

In some embodiments, which can be combined with other embodiments described herein, only the front illuminators 110 projects light to the fluid contained in the container 114 present in the inspection zone 130. For example, the front illuminators 110 may project light before and/or after the transmission mode illuminator 112 and/or the back illuminator 134 project light through the containers 114 and remain off while the transmission mode illuminator 112 and/or the back illuminator 134 project light through the containers 114. In such embodiments, the front illuminators 110 may be utilized for static defect detection.

In other embodiments, only the transmission mode illuminator 112 and/or the back illuminator 134 project light to the fluid contained in the container 114 present in the inspection zone 130. In certain embodiment, which can be combined with other embodiments described herein, each of the front illuminators 110, the transmission mode illuminator 112, and the back illuminator 134 subsequently, and individually, project light to the fluid contained in the container 114 present in the inspection zone 130. In another embodiment, which can be combined with other embodiments described herein, each of the front illuminators 110, the transmission mode illuminator 112, and the back illuminator 134 simultaneously project light to the fluid contained in the container 114 present in the inspection zone 130.

The inspection system 100 further includes the one or more cameras 108. The cameras 108 are positioned to capture images of the fluids in the containers 114 in the inspection zone 130. For example, cameras 108 may be operable to view a front side of the containers 114 such that each of the cameras 108 captures images of at least a portion of the containers 114. As illustrated in FIGS. 1-2, mirrors 136 may be utilized such that the cameras 108 may be placed in the inspection system 100 at varying angles relative to a plane of the containers 114. The mirrors 136 project light such that each camera 108 may capture images of the containers 114 relatively perpendicular to the front side of the containers 114 regardless of the positioning of the cameras 108. Any number and/or positioning of mirrors 136 are readily envisioned to allow the cameras 108 to capture images of the front side of the containers 114.

Each camera 108 is positioned to capture images of at least a portion of the fluid, with all of the cameras 108 capable of imaging an entire surface of the containers 114. Each camera 108 may be a high-resolution camera. The resolution of each camera 108 may be greater than at least 20 MP. For example, the resolution of each camera may be about 25 MP. The cameras 108 may have a frame rate between about 10 FPS and about 15 FPS. For example, the frame rate of each camera 108 may be 15 FPS.

The computer system 116 includes a processor 120 and a data storage 124 (e.g., memory). The processor 120 communicates with the data storage 124. The computer system 116 may also communicate with remote servers 122 via a local connection (for example, a Storage Area Network (SAN) or Network Attached Storage (NAS)) or over the Internet. The computer system 116 may be configured to all one or more of the remote servers 122 to either directly access data (i.e., the images) included in the data storage 124 or to interface with a database manager that is configured to manage the data included within the data storage 124. The computer system 116 may also include components of a computing device, for example, a processor, system memory, a hard disk drive, a battery, input devices such as a mouse and a keyboard, and/or output devices such as a monitor or graphical user interface, and/or a combination input/output device such as a touchscreen which not only receives input but also displays output. The computer system 116 controls the operation of the controller 106. The processor 120 of the computer system 116 may execute software, such as programs and/or other software applications stored in the data storage 124 of the computer system 116, and access applications managed by remote servers 122. In the embodiments described below, users may respectively operate the computer system 116 that may be connected to the remote servers 122 over the communications network. The processor 120 of the computer system 116 may also execute other software applications configured to receive content and information (e.g., images) from the camera 108, and make determinations regarding the fluid contained in the images provided by the camera 108.

In operation, the trigger signal is generated by the sensor 128 when the containers 114 enter the inspection zone 130. The trigger signal is an electric signal. The trigger signal is provided to the trigger timing generator 104. The trigger timing generator 104 provides the timing sequence to the controller 106. The controller 106, based on the timing sequence, causes the front illuminators 110, the transmission mode illuminator 112, and/or the back illuminator 134 to provide pulses of light to the inspection zone 130. The controller 106, also based on the timing sequence, causes the one or more cameras 108 to capture images of the containers 114 and fluid disposed therein while the containers 114 are in the inspection zone 130 and illuminated by one or more of the front illuminators 110, the transmission mode illuminator 112, and the back illuminator 134.

The images captured by each camera 108 are processed by the controller 106. The controller 106 is configured to categorize impurities in the fluid. For example, the controller 106 may identify a position of a dark and light portion of the impurity in an image. Responsive to the position of the dark portion being at a first position and the position of the light portion being at a second position relative to the first position, the controller 106 may determine the type of impurity. For example, as briefly discussed above, in instances where the dark portion (e.g., the first position) is a top position and the light portion (e.g., the second position) is a bottom position relative to the top position, the controller 106 may categorize the type of impurity as glass. As another Example, in instances where the light portion (e.g., the first position) is a top position and the dark portion (e.g., the second position) is a bottom position relative to the top position, the controller 106 may categorize the type of impurity as an air bubble.

In certain embodiments, responsive to a determination that the type of impurity is glass, the controller 106 may signal a sorting system (not shown) of the transportation system 126 to remove the container corresponding to the image being processed by the controller 106. In some embodiments, the controller 106 may compare the image with images in a database, for example, a database in data storage 124. The database may include a library of images of air bubbles in fluids. In some embodiments, the database may include images of fluids without defects and images of fluids with known defects. In some embodiments, the controller 106 is operable to identify a candidate impurity, or an air bubble, in the image based on a similarity between the image taken by the one or more cameras 108 and an image of the database. In some embodiments, an air bubble within the fluid may be identified as a candidate when a library image of an air bubble has similar characteristics to the image taken by camera 108. The candidate impurity, or air bubble, may be identified via a structure similarity index measurement performed by the controller 106. Based on the image comparison, candidate impurities and/or defects in the fluid may be further detected, identified, and/or categorized by the controller 106. The defects may be categorized into a defects report 118 associated with the container 114 which contain the fluid from which the image was captured. Additionally and/or alternatively, the images may be provided to the computer system 116 to be processed and/or displayed. The computer system 116 may utilize image comparison or other technique to detect defects within the fluids disposed in the containers 114 similarly to that as described above, or via manual inspection, by a user, of displayed images.

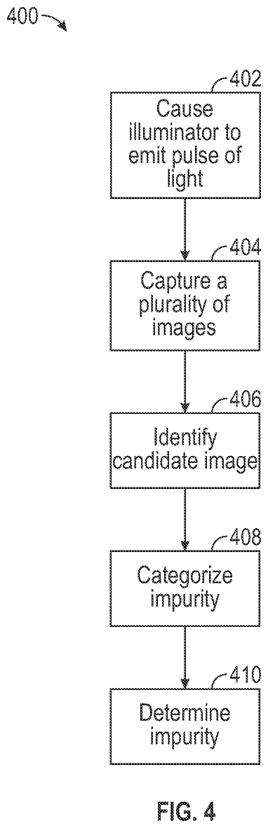

FIG. 4 illustrates a flow diagram of a method 400 for fluid inspection, according to embodiments described herein. FIG. 4 will be described relative to the inspection system 100 of FIGS. 1-2. In certain embodiments, the method 400 may be performed by, for example, the controller 106, while in other embodiments, the method 400 may be performed by the computer system 116. In still other embodiments, the method 400 may be performed by both the controller 106 and the computer system 116. For example, a first subset of the method 400 may be performed by the controller 106 and a second subset of the method 400 may be performed by the computer system 116.

At step 402, the controller 106 causes the back illuminator 134, to emit pulses of light directed to containers 114 disposed in an inspection zone 130 as described above relative to FIGS. 1-2. As outlined above, the back illuminator 134 is positioned at an angle relative to the cameras 108 such that light emitting from the back illuminator 134, as compared to other illuminators in the inspection system 100, create asymmetric illumination within the inspection system 100 (e.g., across the inspection zone 130).

At step 404, the controller 106 signals one or more cameras 108 to capture a plurality of images of the containers 114. At step 406, the controller 106 identifies candidate images in one or more of the images. At step 408, the controller 106 categorizing an impurity in one or more of the candidate images. At step 410, the controller 106 determines a type of impurity (e.g., an air bubble or a glass particle).

While controller 106 was described above as a separate component in inspection system 100, in certain embodiments, controller 106 may reside within computer system 116. Additionally and/or alternatively, in certain embodiments, computer system 116 may perform all functions as described above with respect to the controller 106. Similarly, in certain embodiments, the controller 106 may perform all functions as described above with respect to the computer system 116. In certain embodiments, controller 106 may be representative of the computer system 116. Similarly, in some embodiments, the computer system 116 may be representative of the controller 106. Functions performed by the controller 106 and/or the computer system 116 are not to be limited, and may be interchanged without deviating from the scope of the disclosure.

While the method 400 is described as sequential steps performed in sequence, in other embodiments, the method 400 may be performed in parallel to one or more methods 400 and/or subsets of the method 400. Sequence of the method 400 is for illustrative purposes only and should not be construed as limited to the order in which the steps of method 400 are described.

Although various embodiments of the present disclosure have been illustrated in the accompanying Drawings and described in the foregoing Detailed Description, it will be understood that the present disclosure is not limited to the embodiments disclosed herein, but is capable of numerous rearrangements, modifications, and substitutions without departing from the spirit of the disclosure as set forth herein.

The term “substantially” is defined as largely but not necessarily wholly what is specified, as understood by a person of ordinary skill in the art. In any disclosed embodiment, the terms “substantially”, “approximately”, “generally”, and “about” may be substituted with “within [a percentage] of” what is specified, where the percentage includes 0.1, 1, 5, and 10 percent.

The foregoing outlines features of several embodiments so that those of ordinary skill in the art may better understand the aspects of the disclosure. Those of ordinary skill in the art should appreciate that they may readily use the disclosure as a basis for designing or modifying other processes and structures for carrying out the same purposes and/or achieving the same advantages of the embodiments introduced herein. Those of ordinary skill in the art should also realize that such equivalent constructions do not depart from the spirit and scope of the disclosure, and that they may make various changes, substitutions, and alterations herein without departing from the spirit and scope of the disclosure. The scope of the invention should be determined only by the language of the claims that follow. The term “comprising” within the claims is intended to mean “including at least” such that the recited listing of elements in a claim are an open group. The terms “a”, “an”, and other singular terms are intended to include the plural forms thereof unless specifically excluded.

Depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, for example, through multi-threaded processing, interrupt processing, or multiple processors or processor cores or on other parallel architectures, rather than sequentially. Although certain computer-implemented tasks are described as being performed by a particular entity, other embodiments are possible in which these tasks are performed by a different entity.

Conditional language used herein, such as, among others, “can”, “might”, “may”, “e.g.”, and the like, unless specifically stated otherwise, or otherwise understood within the context as used, is generally intended to convey that certain embodiments include, while other embodiments do not include, certain features, elements, and/or states. Thus, such conditional language is not generally intended to imply that features, elements, and/or states are in any way required for one or more embodiments or that one or more embodiments necessarily include logic for deciding, with or without author input or prompting, whether these features, elements, and/or states are included or are to be performed in any particular embodiment.

While the above detailed description has shown, described, and pointed out novel features as applied to various embodiments, it will be understood that various omissions, substitutions, and changes in the form and details of the embodiments illustrated can be made without departing from the spirit of the disclosure. As will be recognized, the various embodiments described herein can be embodied within a form that does not provide all of the features and benefits set forth herein, as some features can be used or practiced separately from others. The scope of protection is defined by the appended claims rather than by the foregoing description. All changes which come within the meaning and range of equivalency of the claims are to be embraced within their scope.

What is claimed is:

1. A fluid inspection system, comprising:
a transportation system operable to transport a plurality of containers of fluid through an inspection zone;
one or more cameras operable to view a front side of the plurality of containers from a first direction while the plurality of containers are in the inspection zone;
a back illuminator positioned to direct light in a second direction on a backside of the plurality of containers while the plurality of containers are in the inspection zone, the second direction oriented greater than 90 degrees and less than 180 degrees from the first direction; and
a controller operable to:
cause the back illuminator to emit light that illuminates the backside of the plurality of containers in the second direction while the plurality of containers are in the inspection zone; and
cause the one or more cameras to capture a plurality of images of the fluid in the plurality of containers while being illuminated by the back illuminator, wherein the plurality of containers receive more light intensity from the second direction than from other directions illuminating the backside of the plurality of while the plurality of images are being captured.

2. The fluid inspection system of claim 1, wherein:
the first direction is oriented along a plane passing through the inspection zone and substantially perpendicular to the front side of the plurality of containers;
the back illuminator is positioned above the plane; and
no light illuminates the back of the plurality of containers from a direction under the plane while the plurality of images are being captured.

3. The fluid inspection system of claim 1, wherein the second direction is oriented greater than 110 degrees and less than 160 degrees from the first direction.

4. The fluid inspection system of claim 1, wherein the controller is configured to:
identify a candidate image from the plurality of images; and
categorize an impurity in the fluid based on the candidate image.

5. The fluid inspection system of claim 4, wherein the controller is configured to score the candidate image based at least in part on a similarity between the candidate image and characteristics of a known impurity.

6. The fluid inspection system of claim 5, wherein the controller is configured to identify a type of impurity in the candidate image.

7. The fluid inspection system of claim 6, wherein, responsive to a determination that the type of impurity comprises glass, signaling, by the controller, a sorting system to remove at least one container of the plurality of containers corresponding to the at least one image.

8. The fluid inspection system of claim 1, comprising:
at least one front illuminator directed to the inspection zone; and
a transmission mode illuminator directed to an opposing direction of the at least one front illuminator.

9. The fluid inspection system of claim 8, wherein:
the at least one front illuminator and the back illuminator comprise a reflection mode illuminator; and
illumination of the transmission mode illuminator is on a same plane as the plurality of containers.

10. The fluid inspection system of claim 9, wherein at least one front illuminator comprises a first illuminator and a second illuminator directed to the inspection zone at an acute angle relative to a same plane of the transmission mode illuminator and the plurality of containers.

11. The fluid inspection system of claim 8, wherein positioning of the at least one front illuminator, the back illuminator, and the transmission mode illuminator form asymmetric illumination across the inspection zone.

12. The fluid inspection system of claim 1, wherein the controller is operable to compare at least one image with images in a database.

13. The fluid inspection system of claim 12, wherein the controller is operable to identify a candidate impurity in the at least one image based on a similarity between the at least one image and at least one image of the database.

14. The fluid inspection system of claim 13, wherein the candidate impurity is identified via a structure similarity index measurement performed by the controller.

15. A method for fluid inspection, the method comprising:
directing light at a first direction through a container disposed in an inspection zone;
capturing an image of a fluid in the container disposed in the inspection zone from a second direction, an included angle defined between the first direction and the second direction being greater than 90 degrees and less than 180 degrees, wherein the container receives more light intensity from the first direction than from other directions illuminating a backside of the container while the image is being captured; and
identifying an impurity in the fluid based on the image.

16. The method for fluid inspection of claim 15, comprising:
identifying a candidate image; and
categorizing an impurity in the fluid based on the candidate image.

17. The method for fluid inspection of claim 16, comprising scoring the candidate image based at least in part on a similarity between the candidate image and an image of a known impurity.

18. The method for fluid inspection of claim 17, comprising identifying a type of impurity in the candidate image.

19. The method for fluid inspection of claim 17, comprising:
responsive to a determination that the type of impurity comprises glass, signaling a sorting system to remove the container corresponding to the image.

20. A fluid inspection system, comprising:
a transportation system operable to transport a plurality of containers of fluid through an inspection zone;
a plurality of illuminators comprising:
at least one front illuminator directed to the inspection zone;
a back illuminator directed to an opposing direction of the at least one front illuminator; and
a transmission mode illuminator directed to the opposing direction of the at least one front illuminator;
one or more cameras directed to the inspection zone; and
a controller electrically coupled to the plurality of illuminators and the one or more cameras, the controller operable to:
cause the back illuminator to emit pulses of light;
capture a plurality of images of the fluid in the plurality of containers disposed in the inspection zone, wherein the plurality of containers receive more light intensity from the back illuminator than from other illuminators illuminating a backside of the plurality of while the plurality of images are being captured; and
identify an impurity in the fluid based on at least one image of the plurality of images.
